(19) United States
(12) Patent Application Publication
(10) Pub. No.: US 2022/0021455 A1
(43) Pub. Date: Jan. 20, 2022

(54) RADIO-FREQUENCY-OVER-FIBER TRANSMISSION METHOD USING DIRECTLY MODULATED LASER

(71) Applicant: ELECTRONICS AND TELECOMMUNICATIONS RESEARCH INSTITUTE, Daejeon (KR)

(72) Inventors: Joonyoung KIM, Daejeon (KR); Eon-sang KIM, Daejeon (KR); Minkyu SUNG, Daejeon (KR); Jong Hyun LEE, Daejeon (KR); Seung-Hyun CHO, Sejong-si (KR)

(21) Appl. No.: 17/374,466

(22) Filed: Jul. 13, 2021

(30) Foreign Application Priority Data
Jul. 16, 2020 (KR) 10-2020-0087970

(51) Int. Cl. H04B 10/2575; H04B 10/50

(52) U.S. Cl. CPC H04B 10/25759; H04B 2210/006; H04B 10/504

(57) ABSTRACT

Disclosed is a radio-frequency-over-fiber (RFoF) transmission method using a directly modulated laser (DML). The RFoF transmission method to be performed by a head end includes combining a radio frequency (RF) carrier signal and a data signal having a lower frequency band than the RF carrier signal through an RF coupler, modulating the combined RF carrier signal and the combined data signal using a frequency response characteristic of a DML, and outputting an optical signal in which, of RF carrier signals and data signals being generated in a laterally symmetrical form based on an optical carrier frequency through the modulating, an RF carrier signal is suppressed.

### CROSS-REFERENCE TO RELATED APPLICATION(S)

This application claims the priority benefit of Korean Patent Application No. 10-2020-0087970 filed on Jul. 16, 2020, in the Korean Intellectual Property Office, the disclosure of which is incorporated herein by reference.

### BACKGROUND

### 1. Field of the Invention

One or more example embodiments relate to a radio-frequency-over-fiber (RFoF) transmission technology that simultaneously transmits a high radio frequency (RF) carrier signal and a data signal using a low-cost directly modulated laser (DML) in a mobile fronthaul and an indoor distributed antenna system (DAS) that transmit a large volume of mobile traffic.

### 2. Description of Related Art

An analog mobile fronthaul and an indoor distributed antenna system (DAS) that transmit rapidly growing mobile traffic using an analog method instead of an existing digital method are attracting interest. In particular, a radio-over-fiber (RoF) technology that transmits a large-capacity mobile signal after loading it directly on an intermediate frequency (IF) carrier signal or a radio frequency (RF) carrier signal is in great demand.

An IF-over-fiber (IFoF) method using an IF carrier signal may have a link formed using a low-cost directly modulated laser (DML) and an optical receiver based on a positive-intrinsic-negative (PIN) photodiode (PD). However, the IFoF method may require an additional component to upconvert a signal in an IF band back into an RF band, for example, a millimeter-wave (mmWave) band. Thus, the IFoF method may require a remote unit (RU), a local oscillator (LO) (e.g., at mmWave), an RF mixer, a multi-stage RF amplifier, an electric filter, and the like, which may increase the complexity of an end unit or the RU and increase power consumption and costs for maintenance and repair.

In contrast, an RF-over-fiber (RFoF) method using an RF carrier signal may have a simplified structure of an RU because an IF-to-RF conversion is performed at a head end. However, the RFoF method may require a high-cost broadband external modulator, for example, a Mach-Zehnder modulator, and an additional device to monitor and control a condition for driving the external modulator, which may increase the cost and complexity of a system.

### SUMMARY

An aspect provides a method of simultaneously transmitting a radio frequency (RF) carrier signal and a data signal using a directly modulated laser (DML) in an RF-over-fiber (RFoF) link.

According to an aspect, there is provided a radio-frequency-over-fiber (RFoF) transmission method to be performed by a head end including combining a radio frequency (RF) carrier signal and a data signal having a lower frequency band than the RF carrier signal through an RF coupler, modulating the combined RF carrier signal and the combined data signal using a frequency response characteristic of a directly modulated laser (DML), and outputting an optical signal in which, of RF carrier signals and data signals being generated in a laterally symmetrical form based on an optical carrier frequency through the modulating, an RF carrier signal is suppressed.

The modulating may include modulating the RF carrier signal using a first frequency band corresponding to a relaxation oscillation of the DML, and modulating the data signal using a second frequency band that is lower than the first frequency band.

The first frequency band corresponding to the relaxation oscillation may be adjusted through control of an electric current to be injected into the DML or through an external optical injection.

According to another aspect, there is provided an RFoF transmission method to be performed by a remote unit (RU) including receiving, from a head end, an optical signal comprising an RF carrier signal and a data signal, and upconverting the data signal of the optical signal into a frequency band corresponding to the RF carrier signal through a PIN PD that functions as a photo mixer. The optical signal received from the head end is output by combining the RF carrier signal and the data signal having a lower frequency band than the RF carrier signal through an RF coupler, modulating the RF carrier signal and the data signal using a frequency response characteristic of a DML, and suppressing an RF carrier signal of RF carrier signals and data signals, the RF carrier signals and the data signals being generated in a laterally symmetrical form based on an optical carrier frequency band through the modulating.

Of the optical signal, the RF carrier signal may be modulated using a first frequency band corresponding to a relaxation oscillation of the DML, and the data signal may be modulated using a second frequency band that is lower than the first frequency band.

The first frequency band corresponding to the relaxation oscillation may be adjusted through control of an electric current to be injected into the DML or through an external optical injection.

According to another aspect, there is provided an RFoF transmission method including combining an RF carrier signal and a data signal having a lower frequency band than the RF carrier signal using an RF coupler of a head end, modulating the combined RF carrier signal and the combined data signal through a DML of the head end using a frequency response characteristic of the DML, outputting an optical signal in which, of RF carrier signals and data signals being generated in a laterally symmetrical form based on an optical carrier frequency through the modulating, an RF carrier signal is suppressed using a BPF of the head end, receiving an optical signal output from the head end using an optical receiver of an RU, and upconverting the data signal of the optical signal into a frequency band corresponding to the RF carrier signal through a PIN PD in the optical receiver that functions as a photo mixer.

The modulating may include modulating the RF carrier signal using a first frequency band corresponding to a relaxation oscillation of the DML and modulating the data signal using a second frequency band that is lower than the first frequency band.

The first frequency band corresponding to the relaxation oscillation may be adjusted through control of an electric current to be injected into the DML or through an external optical injection.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the disclosure will become apparent and more readily appreciated from the following description of example embodiments, taken in conjunction with the accompanying drawings of which:

FIG. 1 is a diagram illustrating an example of a configuration of a radio-frequency-over-fiber (RFoF) link according to an example embodiment;

FIGS. 2A through 2C are diagrams illustrating examples of a spectrum of a signal measured at each point in an RFoF link according to example embodiments; and

FIG. 3 is a flowchart illustrating an example of an RFoF transmission method according to an example embodiment.

### DETAILED DESCRIPTION

Hereinafter, example embodiments will be described in detail with reference to the accompanying drawings.

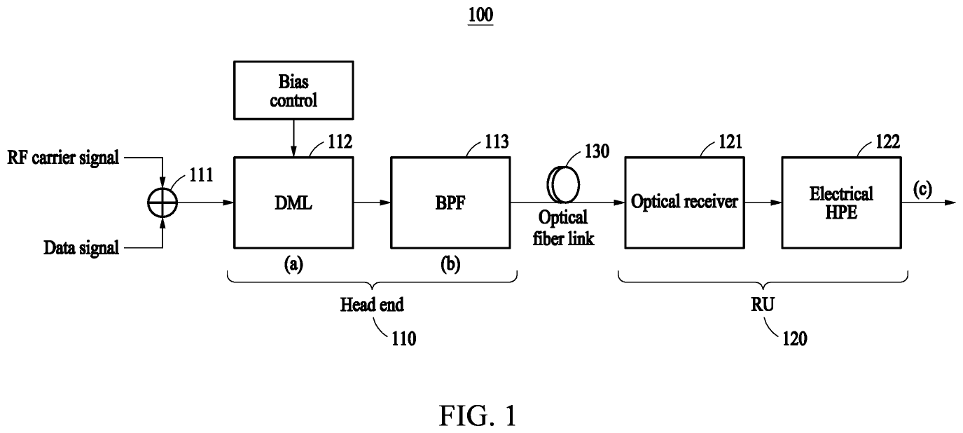

FIG. 1 is a diagram illustrating an example of a configuration of a radio-frequency-over-fiber (RFoF) link according to an example embodiment.

Referring to FIG. 1, an RFoF link 100 may include a head end 110 that converts an electrical signal to an optical signal and outputs the optical signal, and a remote unit (RU) 120 that upconverts a frequency of the optical signal received from the head end 110 and outputs an optical signal with the upconverted frequency. The head end 110 and the RU 120 may be linked through an optical fiber 130.

The head end 110 may receive a combined signal in which a radio frequency (RF) carrier signal (e.g., a millimeter-wave (mmWave) signal) and a data signal (e.g., a baseband signal) are combined using an RF coupler 111. The head end 110 may optically modulate the combined signal received through a directly modulated laser (DML) 112.

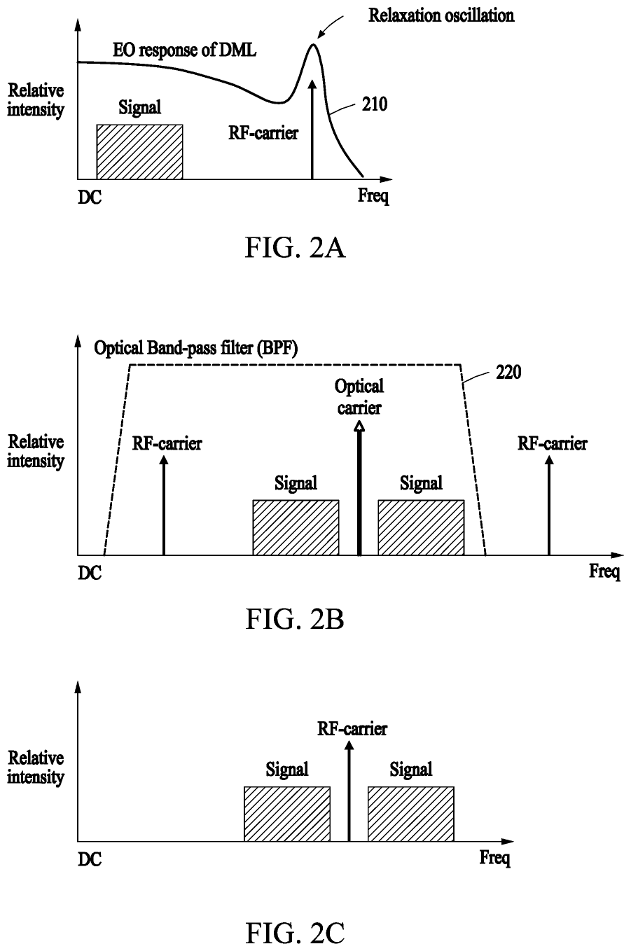

Referring to FIG. 2A, a solid line 210 may indicate a frequency response characteristic of the DML 112. The DML 112 may use a low frequency band with a small variation in relative intensity to modulate a data signal. As illustrated in FIG. 2A, a bump with a narrow width is present in a high frequency band with a large variation in relative intensity, which occurs due to a relaxation oscillation of the DML 112. A frequency band corresponding to this relaxation oscillation may have a narrow bandwidth yet a high gain, and thus the DML 112 may use the frequency band corresponding to the relaxation oscillation to modulate an RF carrier signal.

The head end 110 may control a bias current that is to be injected into the DML 112 or use various methods, for example, injection locking based on an external optical injection, to adjust a first frequency band in which the relaxation oscillation for modulating the RF carrier signal occurs in the high frequency band and a second frequency band for modulating the data signal in the low frequency band.

The first frequency band and the second frequency band may need to be adjusted because the frequency of the RF carrier signal may differ according to a system. For example, there may be a system using 28 gigahertz (GHz) and another system using 60 GHz, and thus the first frequency band and the second frequency band may need to be adjusted according to a system.

For example, when the head end 110 directly modulates the combined signal in which the RF carrier signal and the data signal are combined as illustrated in FIG. 2A using the DML 112, an output optical spectrum may be obtained as illustrated in FIG. 2B. That is, through the optical modulation of the combined signal in which the RF carrier signal and the data signal are combined using the DML 112, RF carrier signals and data signals may be generated in a laterally symmetrical form based on a carrier frequency.

The head end 110 may perform filtering to obtain an optical signal in which, of the RF carrier signals and data signals that are generated in a laterally symmetrical form, an RF carrier signal is suppressed, using a band-pass filter (BPF) 113 having a frequency pass band indicated in a dotted line 220. The head end 110 may perform filtering by selecting the RF carrier signal from among the RF carrier signals generated in the laterally symmetrical form. The head end 110 may then transmit the optical signal to the RU 120 through the optical fiber 130.

The RU 120 may receive the optical signal received from the head end 110 through an optical receiver 121. The optical receiver 121 may function as a photo mixer to upconvert the data signal included in the optical signal into a frequency band of the RF carrier signal and output an optical signal with the upconverted frequency band, as illustrated in FIG. 2C.

The optical receiver 121 may upconvert the data signal into the frequency band of the RF carrier signal through optical beating. For example, when the data signal included in the optical signal, namely, a baseband signal part, is A(t)cos(w₁t), and an RF carrier part included in the optical signal is cos(w₂t), A(t)cos(w₁t)cos(w₂t) may be obtained by photo-mixing of a photodiode (PD) included in the optical receiver 121 and A(t)cos([w₁-w₂]t) may be output as a result.

In the output of the optical receiver 121, both the data signal of the baseband signal part and the data signal with the upconverted frequency may be present, based on the output of the PD. However, since only the frequency upconverted data signal is needed for wireless communication, the RU 120 may remove unnecessary elements present in a baseband through a high-pass filter (HPF).

As described above, the head end 110 may directly modulate the RF carrier signal and the data signal to simultaneously output them using a frequency response characteristic of the DML 112, that is, a characteristic of a relaxation oscillation. The RU 120 may perform a frequency upconversion on the optical signal received from the head end 110 using only the optical receiver 121, and it is thus possible to simplify a structure of the RU 120 in addition to the head end 110 and reduce infrastructure construction costs and operating costs for providers or operators.

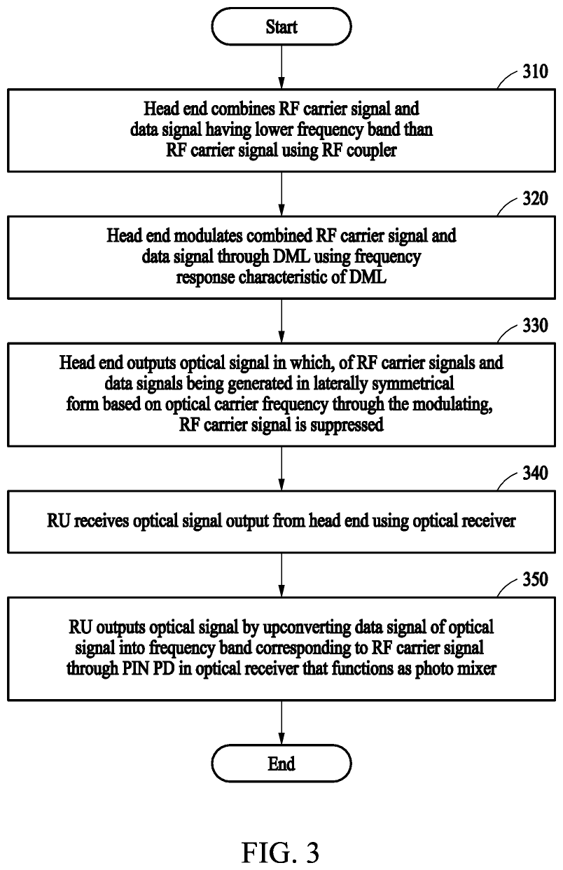

FIG. 3 is a flowchart illustrating an example of an RFoF transmission method according to an example embodiment.

In operation 310, the head end 110 may combine an RF carrier signal and a data signal having a lower frequency band than the RF carrier signal using the RF coupler 111.

In operation 320, the head end 110 may modulate the combined RF carrier signal and the combined data signal through the DML 112 using a frequency response characteristic of the DML 112. The head end 110 may modulate the RF carrier signal by providing a bias current to the DML 112 based on a first frequency band corresponding to a relaxation oscillation of the DML 112. The head end 110 may also modulate the data signal by providing a bias current to the DML 112 based on a second frequency band that is lower than the first frequency band corresponding to the relaxation oscillation.

The first frequency band corresponding to the relaxation oscillation may be adjusted through control of an electrical current to be injected into the DML 112 or through an external optical injection.

In operation 330, the head end 110 may output an optical signal in which, of RF carrier signals and data signals being generated in a laterally symmetrical form based on an optical carrier frequency through the modulating, an RF carrier signal is suppressed.

In operation 340, the RU 120 may receive the optical signal output from the head end 110 using the optical receiver 121.

In operation 350, the RU 120 may output an optical signal by upconverting the data signal of the optical signal into a frequency band corresponding to the RF carrier signal through a positive-intrinsic-negative (PIN) photodiode (PD) in the optical receiver 121 that functions as a photo mixer.

According to example embodiments, it is possible to simultaneously transmit an RF carrier signal and a data signal using a DML in an RFoF link and form the RFoF link that enables a frequency upconversion using only an optical receiver.

According to example embodiments, it is possible to simplify a configuration of an RU, in addition to a head end, and reduce infrastructure construction costs and operating costs.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

In the meantime, the method according to an example embodiment may be implemented as various recording media such as a magnetic storage medium, an optical read medium, and a digital storage medium after being implemented as a program that can be executed in a computer.

The implementations of the various technologies described in the specification may be implemented with a digital electronic circuit, computer hardware, firmware, software, or the combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. The computer programs such as the above-described computer program(s) may be recorded in any form of a programming language including compiled or interpreted languages, and may be executed as a standalone program or in any form included as another unit suitable to be used in a module, component, sub routine, or a computing environment. The computer program may be executed to be processed on a single computer or a plurality of computers at one site or to be distributed across a plurality of sites and then interconnected by a communication network.

The processors suitable to process a computer program include, for example, both general purpose and special purpose microprocessors, and any one or more processors of a digital computer of any kind. Generally, the processor may receive instructions and data from a read only memory, a random-access memory or both of a read only memory and a random-access memory. The elements of a computer may include at least one processor executing instructions and one or more memory devices storing instructions and data. In general, a computer may include one or more mass storage devices storing data, such as a magnetic disk, a magneto-optical disc, or an optical disc or may be coupled with them so as to receive data from them, to transmit data to them, or to exchange data with them. For example, information carriers suitable to embody computer program instructions and data include semiconductor memory devices, for example, magnetic Media such as hard disks, floppy disks, and magnetic tapes, optical Media such as compact disc read only memory (CD-ROM), and digital video disc (DVD), magneto-optical media such as floppy disks, ROM, random access memory (RAM), flash memory, erasable programmable ROM (EPROM), electrically erasable programmable ROM (EEPROM), and the like. The processor and the memory may be supplemented by a special purpose logic circuit or may be included by the special purpose logic circuit.

Furthermore, the computer-readable medium may be any available medium capable of being accessed by a computer and may include a computer storage medium.

Although the specification includes the details of a plurality of specific implementations, it should not be understood that they are restricted with respect to the scope of any subject matter or claimable matter. On the contrary, they should be understood as the description about features that may be specific to the specific example embodiment of a specific disclosure. Specific features that are described in this specification in the context of respective example embodiments may be implemented by being combined in a single example embodiment. On the other hand, the various features described in the context of the single example embodiment may also be implemented in a plurality of example embodiments, individually or in any suitable sub-combination. Furthermore, the features operate in a specific combination and may be described as being claimed. However, one or more features from the claimed combination may be excluded from the combination in some cases. The claimed combination may be changed to sub-combinations or the modifications of sub-combinations.

Likewise, the operations in the drawings are described in a specific order. However, it should not be understood that such operations need to be performed in the specific order or sequential order illustrated to obtain desirable results or that all illustrated operations need to be performed. In specific cases, multitasking and parallel processing may be advantageous. Moreover, the separation of the various device components of the above-described example embodiments should not be understood as requiring such the separation in all example embodiments, and it should be understood that the described program components and devices may generally be integrated together into a single software product or may be packaged into multiple software products.

In the meantime, example embodiments disclosed in the specification and drawings are simply the presented specific example to help understand an example embodiment of the present disclosure and not intended to limit the scopes of example embodiments of the present disclosure. It is obvious to those skilled in the art that other modifications based on the technical idea of the present disclosure may be performed in addition to the example embodiments disclosed herein.

What is claimed is:

1. A radio-frequency-over-fiber (RFoF) transmission method to be performed by a head end, comprising:
combining a radio frequency (RF) carrier signal and a data signal having a lower frequency band than the RF carrier signal through an RF coupler;
modulating the combined RF carrier signal and the combined data signal using a frequency response characteristic of a directly modulated laser (DML); and
outputting an optical signal in which, of RF carrier signals and data signals being generated in a laterally symmetrical form based on an optical carrier frequency through the modulating, an RF carrier signal is suppressed.

2. The method of claim 1, wherein the modulating comprises:
modulating the RF carrier signal using a first frequency band corresponding to a relaxation oscillation of the DML; and
modulating the data signal using a second frequency band that is lower than the first frequency band.

3. The method of claim 2, wherein the first frequency band corresponding to the relaxation oscillation is adjusted through control of an electric current to be injected into the DML or through an external optical injection.

4. A radio-frequency-over-fiber (RFoF) transmission method to be performed by a remote unit (RU), comprising:
receiving, from a head end, an optical signal comprising a radio frequency (RF) carrier signal and a data signal; and
upconverting the data signal of the optical signal into a frequency band corresponding to the RF carrier signal through a positive-intrinsic-negative (PIN) photodiode (PD) that functions as a photo mixer,
wherein the optical signal received from the head end is output by combining the RF carrier signal and the data signal having a lower frequency band than the RF carrier signal through an RF coupler, modulating the RF carrier signal and the data signal using a frequency response characteristic of a directly modulated laser (DML), and suppressing an RF carrier signal of RF carrier signals and data signals, the RF carrier signals and the data signals being generated in a laterally symmetrical form based on an optical carrier frequency band through the modulating.

5. The method of claim 4, wherein, of the optical signal, the RF carrier signal is modulated using a first frequency band corresponding to a relaxation oscillation of the DML, and
the data signal is modulated using a second frequency band that is lower than the first frequency band.

6. The method of claim 5, wherein the first frequency band corresponding to the relaxation oscillation is adjusted through control of an electric current to be injected into the DML or through an external optical injection.

7. A radio-frequency-over-fiber (RFoF) transmission method, comprising:
combining a radio frequency (RF) carrier signal and a data signal having a lower frequency band than the RF carrier signal using an RF coupler of a head end;
modulating the combined RF carrier signal and the combined data signal through a directly modulated laser (DML) of the head end using a frequency response characteristic of the DML;
outputting an optical signal in which, of RF carrier signals and data signals being generated in a laterally symmetrical form based on an optical carrier frequency through the modulating, an RF carrier signal is suppressed using a band-pass filter (BPF) of the head end;
receiving an optical signal output from the head end using an optical receiver of a remote unit (RU); and
upconverting the data signal of the optical signal into a frequency band corresponding to the RF carrier signal through a positive-intrinsic-negative (PIN) photodiode (PD) in the optical receiver that functions as a photo mixer.

8. The method of claim 7, wherein the modulating comprises:
modulating the RF carrier signal using a first frequency band corresponding to a relaxation oscillation of the DML; and
modulating the data signal using a second frequency band that is lower than the first frequency band.

9. The method of claim 8, wherein the first frequency band corresponding to the relaxation oscillation is adjusted through control of an electric current to be injected into the DML or through an external optical injection.
